(19) United States
(12) Patent Application Publication
(10) Pub. No.: US 2010/0143042 A1
(43) Pub. Date: Jun. 10, 2010

(54) Device for Restoring or for Installing the Thermally Insulating External Jacket of Pipes, Tubes, Hoses, Connection Elements and Other Jacketed Elements

(75) Inventors: Nguyen Truong Dinh, St. Laurent d'Agny (FR); Christian Gaillard, La Seyne Sur Mer (FR); Raymond Hallot, Martigues (FR)

Correspondence Address: MCCARTER & ENGLISH, LLP HARTFORD;CITYPLACE I, 185 ASYLUM STREET, HARTFORD, CT, 06103, US

(73) Assignee: CONDAT SA/SAIPEM, Chasse Sur Rhone (FR)

(21) Appl. No.: 12/523,170

(22) PCT Filed: Jan. 17, 2008
(86) PCT No.: PCT/FR2008/000053

§ 371 Date: Feb. 3, 2010

(30) Foreign Application Priority Data
Jan. 17, 2007 (FR) 0700304

(51) Int. Cl. F16L 55/18; F16L 55/168

(52) U.S. Cl. 405/184.1; 138/99

(57) ABSTRACT

The invention relates to a device for repairing and fitting heat insulation capabilities of the external cladding of clad members such as tubular lines, connection members and other clad members, positioned on the seabed, said device consisting of a casing comprising attachment and/or tightening means, suitable for being mounted on said clad members, characterised in that the device comprises, inside the casing thereof, a gel type elastomer heat insulation compound, in the form of a solid or perforated lining/mat, rigidly connected to said casing and compressed by tightening on the clad member during the fitting thereof.

### FIELD OF THE INVENTION

The invention relates to a device for producing or repairing the external cladding of lines with a view to providing or repairing damaged heat insulation.

More specifically, it relates to submarine lines fitted at sea, alone or arranged in bundles, couplings, connections and other members such as valves and any types of accessories and supports associated with said lines.

More specifically, it relates to submarine lines fitted at very low depths for sea oilfield drilling.

The invention also relates to the fitting of heat insulation to be performed at individual points on members particularly couplings, connections with insufficient or no heat insulation and, as such, displaying unacceptable heat losses.

The invention also relates to an elastomer component forming a lining/mat, which is solid or perforated, of a casing of a device for producing or repairing the external heat insulation cladding of members, such as, for example, a line, which, displaying a heat insulation defect, for example, cracking of the existing insulator, needs to be repaired in the heat insulation thereof to eliminate or at least reduce undesirable thermal bridges.

The invention also relates to a plurality of methods for producing the elastomer component associated with the casing.

The invention finally relates to the use of an elastomer component for repairing the external cladding of lines, connection members and other clad members, in particular, positioned on the seabed.

### STATE OF THE RELATED ART

In deep water oil deposit mining systems, the crude oil is routed from the production head located on the surface of the seabed, to the oil tankers, storage barges or storage and/or pumping platforms, by means of complex line systems, generally consisting of metal tubes protected and heat-insulated by very high performance insulating complexes installed at the outer periphery of said lines.

Indeed, the crude oil comes out of the well heads at variable temperatures of the order of 50° C. and up to 150-160° C. in some specific fields. However, in some fields, the oil is paraffinic and generally has high proportions of gas and water, which leads, in the event of the temperature lowering to around 30-35° C., to the creation of precipitation and solidification of the paraffins, forming contractions, or clogging. Generally, these contractions are located at cold points. At these temperature levels (30-35° C.), carbohydrate formation occurs by means of physicochemical reaction between the compressed gas and water, these carbohydrates have the same consistencies as sorbets and tend to create clogging, thus completely blocking the oil flow. As the line is no longer in production, it cools rapidly in a few hours, or a few days and the entire line is then blocked by the solidified paraffin and the carbohydrate created. These incidents are catastrophic and in the event of the occurrence of clogging, particularly when the lines are fitted at very low depths and proceed along the seabed for several kilometres, in water wherein the temperature at very low depths is of the order of 3-5° C.

An extreme level of insulation is thus sought, so that the temperature loss along the line is extremely low and the crude oil arrives at the surface at a temperature of the order of 35-40° C., whereas the temperature thereof at the well outlet is of the order of 50-60° C. For this purpose, very high-performance insulation systems preferentially consisting of two prefabricated coaxial lines generally in 25-50 m long strings are used for standard portions of submarine lines. The ends of said coaxial lines are rendered tight, generally, by forged parts, makings it possible to maintain a high vacuum between said lines. The level of insulation may be improved further by filling said space between said lines with a micro-porous, or nano-porous, material. The strings are then assembled together by welding to form the submarine line fitted on the seabed. These connections have, besides the standard sections, singular points, such as bends, T-connections, automatic connectors, valves and junction sleeves with well heads or bed-surface connection towers, which need extreme insulation, to prevent the creation of cold points locally which would rapidly create localised clogging liable to block the crude oil flow as explained above. These singular points are, generally, insulated with thick syntactic foam shells, assembled around the line members and rigidly connected together by bonding or by adding thermoplastic sheaths of variable thickness covering same partially or completely, the preparation of said members being performed, generally, in the workshop.

The syntactic foam consists of hollow glass microspheres generally coated in an epoxy or polyurethane binder and capable of withstanding implosion under considerable pressures.

The syntactic foam has a high rigidity and a good resistance to the pressure of the seabed, which is roughly 100 bar, i.e. approximately 10 Mpa, for 1000 m of depth of water. However, the combination of the pressure of the seabed, associated with the temperature of the crude oil which may be up to 80 to 100° C., or more, on the external wall of said line, and therefore on the internal wall of the insulation system, finally associated with the temperature of the seabed, therefore a temperature of 3-5° C., applied on the external wall of said insulation system, creates considerable differential stresses which tend to cause a very variable quantity of micro-spheres to implode, which may in some cases be propagated by degrees. This results either in a localised subsidence of the insulation system, or a shortening of the insulation system in the axial direction of said line, thus inducing significant cracking of up to several centimetres, or several dozen centimetres. These cracks or localised subsidences create zones with reduced or almost inexistent insulation and therefore thermal bridges and cold points which are particularly hazardous in terms of paraffin solidification or hydrate formation as explained above.

Multiple methods for repairing lines have been developed. In the majority of cases, this consists of fitting a collar to repair a leak of the fluid carried under pressure in the line, consisting of at least two half-shells encompassing a leak from said line, creating around said line, in the zone of said leak, a tight cavity and injecting a polymerisable compound therein, generally a cement slurry, advantageously combined with epoxy resins and fibrous or metal reinforcements such as needles. Said compound injected between the external surface of the line and the internal surface of the two half-shells acting as a mould in the form of a sleeve, by cross-linking, will thus restore the integrity of said line in terms of tightness and pressure resistance. Furthermore, these technologies are proposed to connect two adjacent lines together, or for connection pieces.

The patent EP0779465 is known, which describes such a collar for repairing submarine lines by forming a tight gap between the collar and the line and a semi-automated handling system for fitting said collar around said line. The collar comprises two half-shells held around the line during the repair thereof, using locking means. The two half-shells are separated by a gap closed by two longitudinal seals positioned between the half-shells and by two seals at each end. Locking means are also provided. The gap between the half-shells and the external surface of the line is filled with a cement, for example, consisting of a mixture of sand and epoxy resin, and, once setting has been achieved, the tool is retrieved and the set slurry is in direct contact with the seawater.

WO03069212 is known, which describes a shell assembly for surrounding a tubular member. The assembly comprises three parts connected together by two joints located at each of the ends thereof, the mobile parts being attached to each other using attachment means. This document also describes the use of cement for sealing the annual gap between the tubular member and the internal surface of the assembled shells. The mortar or slurry introduced into the annual gap after assembly, cross-links, sets and ensures the tightness and mechanical consolidation of the assembly formed by bonding.

Finally, the document FR1477201 describes sleeves that can be used for connecting pipes or for repairing leaks on pipes. Said sleeve, consisting of two half-cylinders is attached around the pipe to be repaired and the gap between the sleeve and the pipe is filled with sealing cement.

Such repair systems associating a mechanical device and mortars produced using cement slurry or duroplastic resins are difficult to control during the deployment thereof on-site, particularly in the case of procedures at very low depths, i.e. depths of 1500 or 2000 m or more. Indeed, at these depths, the entire process must be carried out on-site and controlled from the surface. Furthermore, these depths are subject to considerable pressures (100 bar per 1000 m segment) and very low temperatures of the order of 3-5° C., which interfere with, or even prevent, conventional resin polymerisation of cement slurry setting processes. Moreover, at such temperature and pressure conditions, the viscosity of the various compounds is modified radically, which complicates the preparation, use and injection of such products considerably.

Finally, the purpose of all these injected products is to repair leaks in lines or create connections between lines, said connections needing to be for example free from leaks and needing to withstand mechanically the effect of the internal pressure in the line, and the slurries used, alone or in combination with cross-linkable resins, above all offer mechanical resistance and prove to be poor heat insulators.

To repair faults existing in submarine line insulation systems, it would be possible to envisage injecting, instead of slurries, a compound which has good insulation qualities, such as a compound based on microspheres in an epoxy or polyurethane binder. However, mixing and cross-linking at high pressures and at very low temperatures would be very difficult, or even practically impossible, to obtain, as these processes are already extremely difficult to control in the workshop under normal temperature and pressure conditions.

### SUMMARY OF THE INVENTION

The technical problem to be solved is that of repairing damage to line insulation systems and tubular connection members of lines and, more specifically, submarine lines, said damage being conveyed generally by circular or axial cracking in the thickness of said insulation system or localised subsidences, i.e. localised reductions in the thickness of said insulation system.

As such, the invention relates to a device for repairing and fitting heat insulation capabilities of the external cladding of clad members such as tubular lines, connection members and other clad members, positioned on the seabed, said device consisting of a casing comprising attachment and/or tightening means, suitable for being mounted on said clad members, characterised in that the device comprises inside the casing thereof, a gel type elastomer heat insulation compound, in the form of a solid or perforated lining/mat, rigidly connected to said casing and compressed by tightening on the clad member during the fitting thereof.

The invention also relates to methods for producing the gel type elastomer compound.

The invention finally relates to the use of the device for repairing and fitting insulating capabilities of the external insulating cladding of clad members, such as tubular lines, connection members and other clad members, positioned on the seabed at very low depths.

### DETAILED DESCRIPTION OF THE INVENTION

According to the invention, the device for repairing and fitting insulating capabilities of the external insulating cladding of clad members immersed at low depths, enables the reduction, or elimination, of thermal bridges resulting from in-situ deteriorations in the operating conditions of a facility and/or the design of said facility.

According to the invention, the thermal bridge is eliminated by filling, partially or completely, the cracks or damage appearing in the insulating material, by means of the gel type elastomer compound and/or by creating an enclosed space defined by the gel type elastomer compound having trapped during the fitting of the device, a small quantity of seawater, said small quantity of water stabilising thermally with the temperature of the line wherein the oil is flowing and said elastomer compound acting as an insulation means substantially restoring the continuity of the insulation of the line.

In a preferred version of the invention, during the positioning of the device, the gel type elastomer compound having the form of a solid mat is compressed considerably and deformed by the circular tightening applied by the casing, until the cracks of a cladding to be repaired are completely or partially sealed. If the gel type elastomer compound has the form of a perforated, hollowed mat, it may be in the form of a frame, the heat insulation being obtained by the compression of the elastomer compound in the form of a frame which traps a small quantity of seawater, said seawater contributing to the heat insulation of the repaired line.

The gel type elastomer compound is a heat-insulating material with pronounced elastomeric properties and, as such, a high malleability. It is practically incompressible and withstands perfectly, without losing the mechanical qualities thereof, or the excellent resistance to creep thereof over time, or the insulation performances thereof, the considerable pressures in the deep sea, i.e. substantially 250 bar for a water depth of 2500 metres.

More specifically, the gel type elastomer compound, by means of the elastomeric properties thereof and the application thereof by means of compression, in the form of a solid or perforated lining/mat is adapted in-situ to the geometry of the fault to be repaired and/or covered tightly, said geometry not possibly being known precisely in advance. This geometry of the cladding defect may be in the form of a crack, contraction, break, gap, void. The gel type elastomer compound in the form of a lining/mat will, by means of compression, be deformed and seal partially or completely, by means of penetration of the elastomer compound in the voids of the geometric defects of the damaged cladding, due to the elastomeric properties thereof.

The gel type elastomeric component is thus comparable to a thick “compress” completely surrounding or locally insulating the defective part of a line with respect to the ambient environment.

In the case, for example, of excessive cracking, the gel type elastomer compound in the form of a perforated or hollow lining/mat forming a frame, with or without base, said base being preferentially formed of the same material as the frame, is arranged on the periphery of the crack, the casing closing the gap created tightly.

Said gel type elastomer compound of the device, according to the invention, is advantageously associated with a substrate ranging from rigid to flexible to facilitate the handling, use and attachment thereof to the casing, said attachment to the casing possibly being performed by mechanical means such as riveting, screwing and other mechanical means or by chemical means such as bonding.

According to the invention, the gel type elastomer compound consists of at least one elastomeric polymer which may be of the thermoplastic type or polysiloxane or polyurethane or another synthetic or natural elastomer.

According to a first type of elastomer, the elastomer compound consists of at least one thermoplastic elastomeric polymer and at least one hydrocarbon base and optionally additives such as biocidal agents and antioxidant agents, the whole forming a gel once applied.

As such, the thermoplastic elastomeric polymer according to the invention is selected in the group consisting of di or tri-block sequenced copolymers which may be linear, branched, multi-branched or have star branching.

The term multi-branched implies the presence of a plurality of branches in the morphology of said copolymer.

The di or tri-block copolymer used in the composition is selected from poly(styrene-ethylene-butylene-styrenes), poly(styrene-ethylene-propylene-styrenes), poly(styrene-ethylene-propylenes), poly(styrene-ethylene-butylenes), poly(styrene-ethylene-ethylene-propylene-styrenes) taken alone or in a mixture.

These di or tri-block copolymers used in the gel type elastomer compound are advantageously combined with at least one polymer or copolymer selected in the group of poly(styrene-butadiene-styrene) (SBS), poly(styrene-butadiene) (SB), poly(styrene-isoprene-styrene) (SIS), poly(styrene-isoprene) (SI), poly(styrene-ethylene-propylene) (SEP), low-viscosity poly(styrene-ethylene-propylene-styrene) (SEPS), low-viscosity poly(styrene-ethylene-butylene-styrene) (SEBS), poly(styrene-ethylene-butylene) (SEB), polybutylene, poly(ethylene-propylene) (PE), poly(ethylene-butylene) (EB), polypropylene, or polyethylene.

Preferentially, the selected thermoplastic elastomer polymers used in the composition of the gel type elastomer compound, according to the invention, are selected from high-viscosity di or tri-block copolymers wherein the morphologies are, as a general rule, sequenced according to a structure A-B-A, where each element A is a polystyrene polymer type vitreous segment and where each element B is an elastomer segment forming a block from a polymer of poly(ethylene-butylene), poly(ethylene-propylene), or poly(ethylene-ethylene-propylene).

The description of these morphologies is well known and is particularly found in the literature relating to the polymers known as Kraton® and the derivatives thereof.

The poly(ethylene-butylene) or poly(ethylene-propylene) and polystyrene parts are incompatible and form a two-phase system consisting of submicronic vitreous block domains A interconnected by flexible block chains B. These domains form cross-linking nodes and make it possible to reinforce a three-dimensional structure. This meshed structure having elastomeric physical behaviour is reversible with the temperature. By heating the elastomeric gel above the melting points of said cross-linking nodes, the structure is temporarily destroyed and behaves like a liquid, and may be reconstituted by lowering the temperature again.

The cross-linking is somewhat physical which is reversible at the melting point of the vitreous domains, unlike chemical cross-linking, by means of a cross-linking agent, which is irreversible and results in non-meltable materials.

According to the invention, the at least one hydrocarbon base used in the gel type elastomer compound forming a lining/mat, may be selected in the group consisting of light hydrocarbons such as kerosene, gas oil, white-spirit, optionally linear paraffins, having a varied molecular weight, mineral oils resulting from petrochemicals or oil refining such as paraffin, naphthene bases, hydro-refined, hydro-cracked or hydro-isomerised bases, optionally dearomatised solvents, vegetable oils such as rapeseed, sunflower, soya, palm oil, or animal oils such as suet, lard or others, polyalphaolefins (PAO) or isopolyalphaolefins, polyisobutylenes (PIB) or polybutenes having varied molecular weights, polyalkyleneglycols (PAG), fatty esters, fatty alcohols, fatty ethers.

Preferentially, the hydrocarbon bases used in the composition of the gel type elastomer compound, according to the invention, are selected in the group of paraffinic solvents, paraffinic mineral oils or optionally linear paraffins.

According to a first embodiment when the elastomeric polymer is thermoplastic, the composition comprises:

a) from 1% to 30% by weight and preferentially from 2% to 20% by weight of at least one elastomeric polymer or copolymer, preferentially of the sequenced di or tri-block type;

b) from approximately 99% to approximately 58% by weight of at least one hydrocarbon base;

c) optionally between 0.1% to 6% of a biocidal agent and between 0.1% and 6% of an antioxidant agent.

Such a material is versatile in terms of physical properties in that the cross-linking performed between polymer chains is physical in nature and, as such, is completely reversible with the temperature. It is thus possible to obtain a transition from a solid state, elastomeric in nature, to a liquid, by heating the material and vice versa.

According to a second type of elastomer, the gel type elastomeric component consists of at least one polysiloxane elastomeric polymer.

More generally, other types of elastomers of natural or synthetic origin such as polyurethane ether or ester elastomers, polyisoprenes, butadiene styrene copolymers, polybutadienes, nitriles, butyls, polychloroprenes, butadiene acrylonitriles, natural rubbers and others may be prepared in the form of gel and, as such, are suitable for use in the composition of the elastomer compound.

The gel type elastomer compound according to the invention may advantageously comprise in the composition thereof a biocidal agent, acting simultaneously as a bactericide and fungicide and the purpose of which is to prevent any risk of biological degradation of the elastomer compound in the marine environment in question.

Any wide-spectrum biocidal agent with a bactericidal and fungicidal action well known in the prior art may be used in the composition.

Furthermore, the gel type elastomer compound according to the invention may also advantageously comprise antioxidant agents for example from the amine or phenol family, or the suitable association of both to protect in some cases of formulations or applications the thermal and antioxidant stability of the composition.

The elastomer compound, in gel form, has the physical appearance of a very flexible elastomer. Such a material is particularly versatile in the applications it enables. Indeed, it is possible to modify the mechanical characteristics of the elastomer in gel form by modifying the composition of said compound.

The gel type elastomer compound is a transparent material, physically presented in the aspect of a volume of diverse and varied shapes interacting with the casing thereof. As mentioned above, the most common form is a thick parallelepipedic mat to be applied on the defect to be eliminated such as a crack and fill and insulate same thermally, by means of compression.

However, the gel type elastomer compound may also be in the physical form of seals, for example rectangular cross-section seals, having an appearance somewhat similar to a frame which is applied around the defect to be corrected, such as a crack, a cold point, or a zone to be isolated from the ambient marine environment, with the contribution of the casing, in order to create a heat-insulating barrier between the seawater at 3-5° C. and the immersed line substantially at the temperature of the fluid circulating therein.

When the gel type elastomer compound is in the form of a frame, it may comprise a base and said base may advantageously be made in the same material as said frame.

The elastomer compound may consist of a single material and, in this case, appear to be single-layer or be made of a plurality of different materials, in successive layers, forming a multi-layer, for example, for obtaining a contact layer with the cladding of the clad member, displaying distinct specific properties from the layer in contact with the substrate or a core layer.

According to the invention, the production of the gel type elastomer compound, when produced using thermoplastic polymers, is as follows:

According to a first method, the method consists of introducing all the compounds, i.e. the elastomer copolymer and the hydrocarbon base, and the additives used in the composition, and mixing same at ambient temperature in a reaction vessel, and rapidly heating the mixture to the melting point of the final elastomer gel, substantially close to the melting point of the elastomeric copolymer used. At this temperature, producing a slight vacuum eliminates any air bubbles present in the viscous liquid. The gel formed, in the liquid state at this temperature, is poured without delay into a mould of a suitable shape for the application in question, and cooled to ambient temperature, thus forming a solid or perforated elastomeric solid, the shape of which may be, for example, a parallelepiped or a parallelepipedic frame optionally provided with a base. The gel type elastomer compound forming the solid or perforated lining/mat is then released from the mould.

According to the method, the elastomer compound is thus produced under a) stirring by mixing the elastomeric polymer, the hydrocarbon base and any additives, b) followed by heating to the melting point of the gel type elastomer compound, associated with deaeration, c) followed by hot casting at the same temperature into a mould and d) cooling of said compound, in the mould, followed by e) release of said compound produced from the mould at ambient temperature.

According to another method for producing the gel type elastomer compound, with a pre-gelling phase, a low proportion of the sequenced thermoplastic copolymer is introduced in a first step (i) in the hydrocarbon base, of the order of 0.5% to 10% by weight with reference to the mixture, and any other additives. This pre-mixture is then heated to the melting point of the sequenced thermoplastic copolymer.

The medium formed is then cooled, to ambient temperature, in a second step (ii).

The additional sequenced thermoplastic copolymer is added to the pre-mixture in a third step (iii), so as to obtain the final percentages of sequenced thermoplastic copolymer. The mixture obtained is then stirred vigorously while being maintained at a low temperature, said low temperature preventing any premature gelling of the mixture formed. As the pre-gel is significantly aerated, said pre-gel is subjected to a vacuum phase until a bubble-free mixture is obtained.

In a fourth step (iv), the filling of the mould, to obtain the elastomer compound, is performed using a low air flow rate pump, taking care to incline the mould and prevent any air bubble formation during filling. A positive pressure may be applied to the membrane covering the mould. The mould is then placed in an oven at a temperature at most equal to that of the gel melting point during the period of time required for definitive gelling. In a fifth step (v) the gel type elastomer compound is cooled to ambient temperature and released from the mould in the form of a lining/mat.

According to preferential embodiment conditions, the mixture formed from the pre-mixture and the additional sequenced thermoplastic copolymer is subjected to vigorous stirring while being maintained at a temperature not more than equal to 35° C.

The mixture poured into the filled mould is heated to a temperature of the order of 90° C. for a time between 10 and 12 hours.

The aim of this first step (i) is to thicken the hydrocarbon base so as to prevent the risk of sedimentation of the copolymer grains when adding the 99.5% to 90% remaining copolymer.

Other methods for producing the gel type elastomer compound may be envisaged, in that the gel behaves like a thermoplastic material, i.e. when the elastomeric polymer of the composition is thermoplastic, and, as such, it may be formed using any plastics technology application techniques such as extrusion, injection moulding, calendering, once the compounds, i.e. the copolymer and the hydrocarbon base and any additives, have been mixed, depending on the desired physical forms.

The physical characteristics of the gel type elastomer compound are directly dependent on the composition thereof and the production method thereof. Some of these characteristics are preferentially selected with respect to the usage constraints and are more specifically:
a maximum penetration resistance force describing the firmness of the gel, which must be at least 14 Newton when measured with a texturometer equipped with a 40 mm hemispherical probe operating at a rate of 1 mm/sec, per compression/decompression cycle.
a dropping point of at least 100° C. when measured as per the standard ASTM D566, when the elastomeric polymer is thermoplastic.
an elongation at rupture of at least 100%.
a load at rupture of at least 0.5 MPa.

The gel type elastomer compound is used in the device as follows:

The gel type elastomer compound is advantageously associated with a substrate thus forming a multi-layer composite.

Indeed, due to the great omnidirectional flexibility thereof, the gel type elastomer compound is advantageously associated with a substrate providing mechanical resistance properties with a view to the use thereof as a solid or perforated lining/mat in the device for repairing the external insulating cladding of clad members, for example lines. This solid substrate also makes it possible to attach the gel type elastomer compound on the casing, by means of mechanical attachments, such as, for example, riveting, screwing, or by other mechanical assembly means, or by means of chemical attachments, such as, for example, bonding, adhesive force, heat-sealing or other means, particularly according to the nature of the casing.

This substrate advantageously has a developable surface, such as a rectangular plane sheet of thermoplastic material, such as polyethylene or polypropylene or any other material in a similar physical form that, due to the flexibility thereof, when associated with the elastomer compound mat, can be rolled round to encompass, for example, the damaged external insulating cladding zone of a line to be repaired.

In a preferred version of the invention, said substrate will advantageously consist of a thin metal sheet, for example stainless steel, preferentially cooperating with a grid rigidly connected to said sheet, said grid acting as an anchor for the gel type elastomer compound, during the moulding of said compound.

In the case of a direct heat seal or direct heat adhesion, the end composite forms a multi-layer with an intimate bond between the elastomer compound in gel form and the flexible or semi-rigid substrate which is preferentially a thermoplastic material.

In such a configuration, the multi-layer composite is produced as follows: the method described above for producing the elastomer compound in gel form is applied. After vacuum degassing and before casting, the mould is preheated to a temperature close to the softening point of the thermoplastic material forming the substrate. Said substrate, for example a polyethylene sheet, is positioned at the base of the mould and is softened due to the temperature of said mould. The degassed liquid elastomer compound is then poured directly onto said softened substrate. The whole is maintained at this temperature for a period of 15 to 30 minutes in order to ensure optimal adherence of the gel on the thermoplastic substrate. However, the temperature is maintained at a level such that there is no risk of degradation or contraction of the thermoplastic substrate liable to be caused by potential overheating. Satisfactory adherence between the two materials, the substrate and the gel, is observed, through the homogeneity of the colour of the interface, but also in the cleaving force measurement.

In the case of bonding or specific adhesion, the bond between the gel type elastomer compound and the substrate may also be produced by assembly using a specific adhesive. The gel type elastomer compound is then assembled on the substrate by means of adhesives well known to those skilled in the art, capable of retaining the flexibility thereof to make it possible, for example, to roll the device around a clad tube to be repaired.

The substrate is thus in the form of a semi-rigid or flexible sheet or panel capable of being curved to mould the surface of the line to be repaired by adopting a tubular shape.

The multi-layer composite formed, i.e. formed from the gel type elastomer compound and the substrate intimately bound with said elastomer compound, is then assembled, by means of the substrate, on the internal surface of the casing of the device.

The elastomer compound in gel form associated with a substrate forming a multi-layer composite is assembled with the casing to form the device, forming, for example, a collar once fitted, moulding the cylindrical shape of the line. The attachment and/or tightening means at each of the ends of the casing thus enable the attachment and tensioning of the casing and the compression of the elastomer compound on the cladding to be repaired.

The casing may be a flexible or semi-flexible sheet, capable of being rolled or folded around, to encompass the line, and having a sufficient tensile strength to enclose said line and apply this pressure.

The casing of the device, according to the invention, may consist of various materials of metal origin such as, for example, special stainless steels, titanium, or of organic origin, or be made of composite materials, such as, for example, thermoplastic elastomers or a rubber, reinforced by a mesh of synthetic or metal fibres.

This casing is in the form of a rectangular sheet, having a size enabling the repair of the clad member. The length of the casing is, for example, such that it is equivalent to the perimeter of a theoretical circle of a diameter equal to the sum of the initial diameter of the cladding of the line in a sound zone and twice the thickness of the elastomer compound mat, in the case of an elastomer compound not penetrating the cracks to be repaired or only penetrating said cracks slightly.

If the elastomer compound needs to penetrate into the cracks or defects, said diameter of the theoretical circle should be equal to the sum of the initial diameter of the cladding of the line and 1.8 to 1.6 times the elastomer compound mat thickness, depending on whether moderate or significant penetration inside the cracks is sought.

This casing advantageously comprises on the sides thereof returns perpendicular to said casing forming radial protections once the casing has been fitted on the collar.

The two ends of the elastomer compound forming the lining/mat, in the case of a solid volume and not a frame, are in this case joined, once the casing has been fitted on the line to be repaired.

The casing is preferably made of one part which is rolled around, the edges thereof joining to completely encompass the circumference of the clad member to be repaired.

The casing consists of two semi-tubular shell type parts each provided with complementary attachment means to those of the other half-shell which engage with each other to attach the two semi-tubular shells to each other so as to create compression of the elastomer compound against the clad member to be repaired.

The attachment and/or tightening means of the casing on the clad member to be repaired consist of any known mechanical systems such as, for example, two metal bars and a screw/nut type flange, for example, or any other mechanical system for attaching and tightening the casing around the line to be repaired or more generally the clad member to be repaired.

The attachment and tightening means of the casing may for example be a rod attached onto the casing by bending the two ends of the flexible or semi-rigid casing around said rod, and receiving a screw/nut type mechanism, or a fastening mechanism attaching and tightening the casing forming a collar around the gel type elastomer compound covering the external cladding of the line to be repaired.

The attachment and/or tightening means engage with the casing so as to compress the elastomer component against the line of the clad member to be repaired.

The attachment and/or tightening means are rigidly connected to the casing and comprise two complementary parts mounted on the two opposite edges of the sheet or panel substrate and engage with each other to attach the casing by means of tightening against the line or clad member to be repaired.

The device may be fitted on the cladding to be repaired in various modes:

According to a first fitting mode which fills the crack:

The device is fitted around the cladding of the line to be repaired, shaped by a suitable tool, and tightened around the cladding of the line to form a collar. This positioning of the device is performed by a tool comprising at least two mobile half-jaws actuated for example by hydraulic cylinders, said tool is handled on the seabed by an automatic submarine equipped with a handling arm and hydraulic units, controlled from the surface.

The gel type elastomer compound is sufficiently malleable for the deformation thereof to be possible, when subjected, via the casing, to an intense radial tightening around the cladding to be repaired, during the closing movement of the mobile half-jaws of the tool. The elastomer compound is thus compressed and partially or completely penetrates the cracks to be filled, while retaining an additional thickness in the adjacent sound zones.

According to a second installation mode, an enclosed space, filled with seawater, is created around the crack or identified cold points reducing the risks of heat convection.

Using this approach, it is thus possible to reduce the quantity of elastomer compound used by only placing said gel type component at the sealing interfaces. The gel type elastomer compound takes the form of a frame in this case.

Similarly, the gel thickness may be increased at certain points of the cladding to be repaired to increase the insulation properties locally.

The device thus has the following applications:
repair of the external heat insulation cladding of clad members, in particular lines, alone or arranged in bundles, couplings, connections, and other clad members such as valves, particularly positioned on the seabed for oil mining.
the fitting of heat insulation to be performed at individual points on members particularly couplings, connections with insufficient or no heat insulation and, as such, displaying unacceptable heat losses.

### FIGURES

The invention will be understood more clearly through the referenced description of the figures described hereinafter, said figures being merely illustrative and non-limitative in nature of a device for repairing the external insulating cladding of clad members, for example submarine lines, according to the invention.

FIG. 1 represents a side view of an intervention vessel located perpendicular to a junction sleeve between a submarine line and a well head with a view to repairing the damage to the insulation system thereof.

FIG. 2 represents a side view of a portion of the junction sleeve displaying various types of damage.

FIG. 3A is a sectional front view of a line displaying damage to the insulation system thereof, an elastomer compound mat handling tool, handled by an ROV, an automatic submarine controlled from the surface, descending to encompass said line.

FIG. 3B is the side view relative to FIG. 3A, detailing the descent of the tool overlapping on a series of damaged points.

FIG. 4A represents a sectional front view of a line equipped with the elastomer compound mat thereof, once the assembly has been completed and the attachment bolts tightened.

FIG. 4B is the side view relative to FIG. 4A, the mat only being applied on the cylindrical surface of the insulation system, the water remaining trapped inside.

FIG. 4C is the side view relative to FIG. 4A, the mat being applied and firmly compressed to partially or completely fill the cracks.

FIG. 5A represents a top view of a rectangular, plane elastomer compound mat.

FIG. 5b is the sectional view relative to FIG. 5A detailing the plane elastomer compound mat, a substrate consisting of a polyethylene sheet rigidly connected thereto, the whole being represented respectively in a plane configuration, in a quasi-semi-circle with a view to being gripped by the handling tool, and in the form of a circle to completely encompass the insulation of the line to be repaired.

FIG. 6 is a similar view to that in FIG. 5B, and represents a half-shell to be bent and fitted in the right or left jaw of the tool in FIG. 3A-3B.

FIGS. 7A-7B represent the sectional view of a substrate consisting of a plane stainless steel sheet, whereon a grid rigidly connected thereto is added, respectively before and after duplicate moulding of plane elastomer compound mat.

FIGS. 8A-8B respectively represent a top view and a sectional view along XX of an elastomer compound mat in the form of a frame in the left part of the figure and a mat having a localised extra thickness to fill a specific defect of the cladding to be repaired.

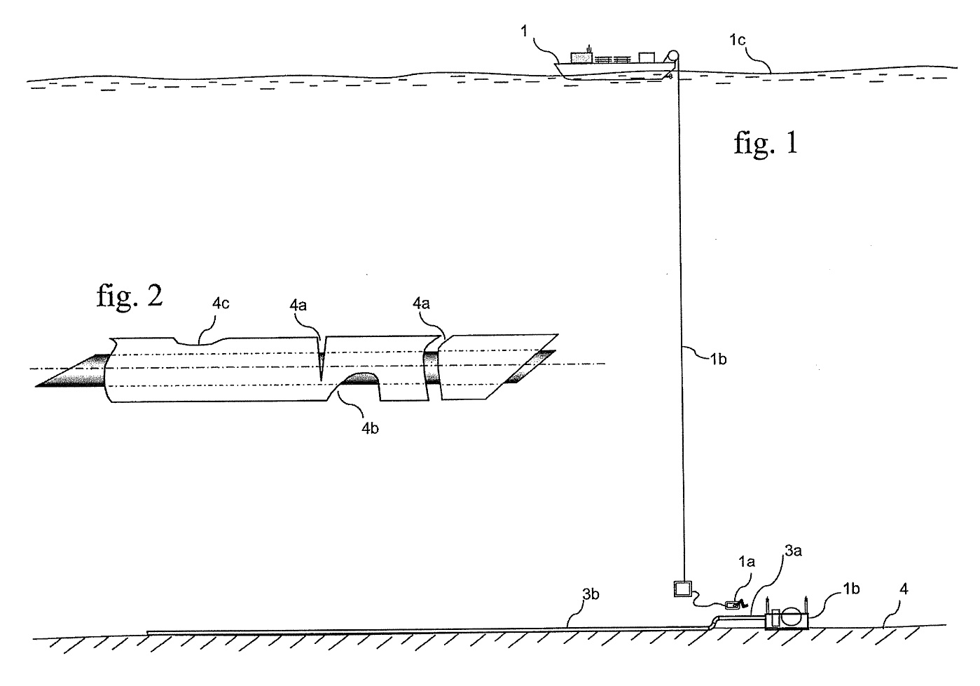

FIG. 1 represents an intervention vessel 1 equipped with a submarine intervention robot (ROV) la located in the vicinity of a well head 1b located at a depth of 1500 m, to perform a procedure on the insulation cladding 2 of a connection sleeve 3a connecting a submarine line 3b fitted on the seabed 4, to said well head 1b.

FIG. 2 represents a side view of a portion of line 3 clad with an insulating complex 2 displaying damage such as cracks 4a, detached portions 4b or localised cavities 4c, caused, for example, by differential stresses induced in the insulator by variations in the temperature between the wall of the line at a high temperature and the seawater at 3-5° C., combined with the pressure of the seabed or the localised implosion of the microspheres forming the insulating complex.

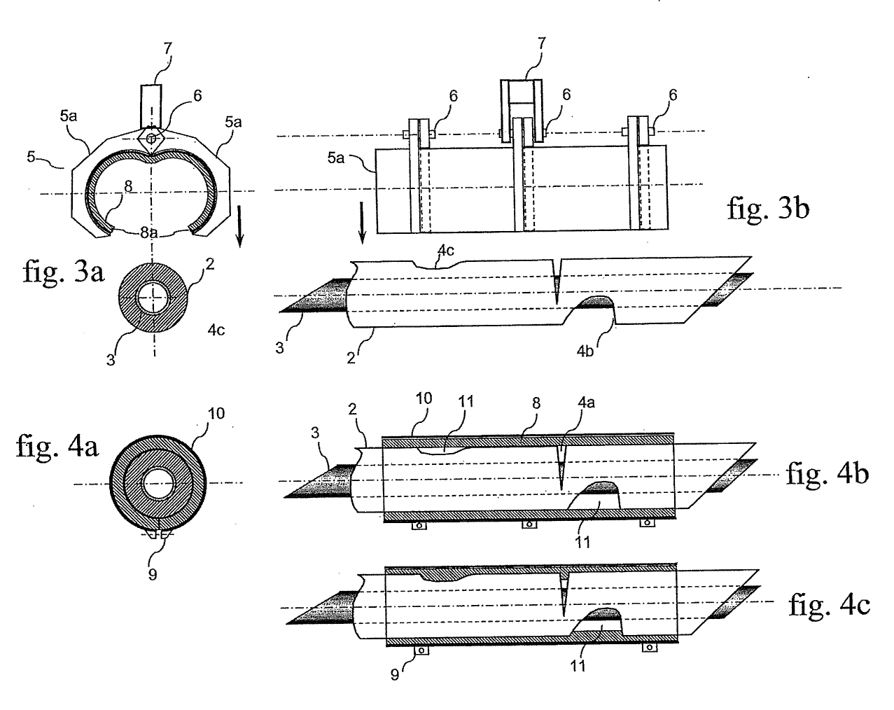

FIG. 3a represents a sectional front view of a line 3 and an insulation system displaying damage 4a-4b-4c above which the handling arm, not shown, of an ROV, not shown, holds in 7 the fitting tool 5 consisting of two jaws 5a hinged in 6 and actuated by hydraulic cylinders not shown. The tool holds an elastomer compound mat 8 consisting of a single mat shell 8. The tool is lowered onto the line and the two jaws are closed and tightened firmly by actuating the cylinders not shown. Finally, a lock, consisting for example of a bolt, is tightened in 9 to perform the definitive closure of the mat encompassed by the casing 10 thereof, as shown in FIG. 4a.

FIG. 3b is the side view corresponding to FIG. 3a detailing the damage 4a-4b-4c of the cladding and the hinge axes 6 of the jaws 5a.

FIG. 4b, corresponding to FIG. 4a, represents a sectional and side view of the elastomer compound mat 8 and the casing 10, and a side view of the damaged cladding 2 and the line 3. In this view, the perimeter of the casing 10 is adjusted such that, once completely tightened, said mat is in intimate contact with the sound cladding portion, said mat not penetrating substantially into the cracks and various defects. This results in limited volumes 11 consisting of seawater at the temperature of the line, and therefore the circulating fluid, but the heat exchanges with the seawater at 3-5° C. are attenuated radically by the thickness of said mat facing said water volumes 11.

In FIG. 4c similar to FIG. 4b, the perimeter of the casing is reduced, for example by 5 cm with respect to that in FIG. 4b, but the thickness of the mat is retained, which results, following the complete tightening of the device, in further compression of said mat, which will be deformed due to the malleability thereof and enter the cracks and the various defects to absorb same either partially or completely. When the jaws 5a of the tool 5 are closed and the elastomer compound starts to enter the cracks and the damaged points, the whole not being completely closed, water may escape via the lower generatrix, close to the closing latches. When the opposing faces 8a of the segments of the mats touch each other and press against each other, the residual water 11 is trapped and can no longer come out.

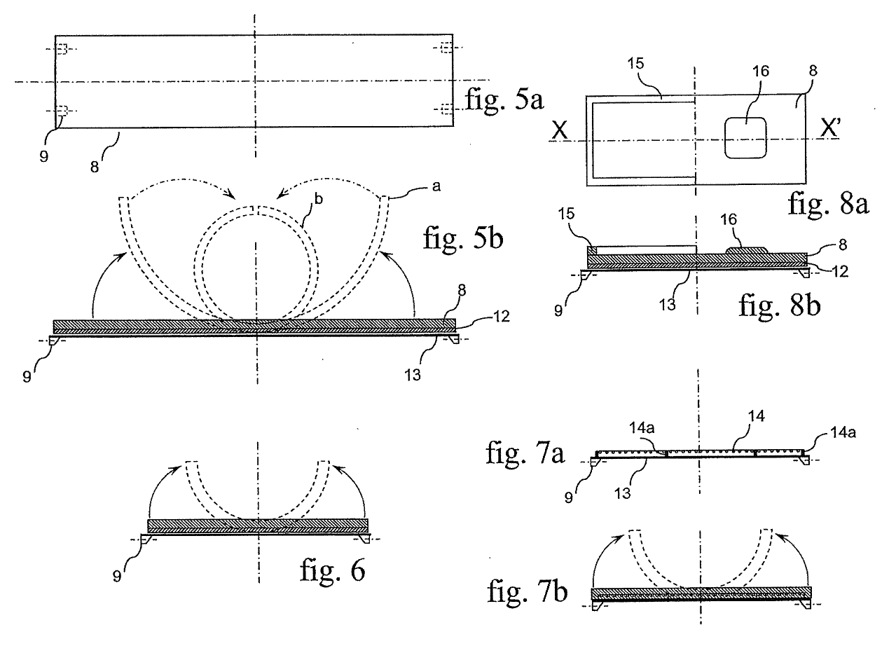

FIG. 5a represents a top view of a flat elastomer compound mat 8, having a parallelepipedic shape.

FIG. 5b is the sectional side view corresponding to FIG. 5a, detailing the 150 mm thick elastomer compound mat 8, a rigid substrate 12 consisting of a 6 mm thick polypropylene sheet, assembled by melting with said mat, said substrate being bonded on a casing 13 consisting of a 4 mm thick stainless steel sheet. The half-latches 9 are attached to each of the ends of the casing 13. The production and transport are performed flat, and the whole is bent so as to obtain the shape a to be inserted into the jaws 5a of the tool 5, said tool completing the bending so as to achieve the final shape b following the fitting around the damaged cladding.

FIG. 6 represents a half-length elastomer compound mat, thus corresponding to a half-shell. The half-shell, after bending, is fitted on each of the jaws 5a of the tool 5.

FIGS. 7a-7b represent a sectional and side view of a preferred prefabrication mode of the elastomer compound mat, represented before casting said compound (7a) and after casting (7b). FIG. 7a represents the stainless steel casing 13 topped with a tight-mesh grid 14 kept at a distance, for example 2 cm from said casing and rigidly connected thereto by supports 14a.

The elastomer compound is then cast in place and the grid is then integrated in the mass of the mat, thus providing the mechanical line for bending and handling the whole for the integration thereof in the jaws 5a of the tool 5, and for the final fitting thereof on the cladding to be repaired.

FIGS. 8a-8b represent respectively a top view and a sectional side view of a mat 8 rigidly connected to a substrate 12, in turn rigidly connected to a casing 13 equipped with latches 9, the mat having, in the left part of the figure, a frame shape 15 and in the right part a localised extra thickness 16, of elastomer compound mat, to fill a particular defect of the cladding to be repaired.

The method for repairing the insulation of clad members to be repaired thus comprises the steps consisting of positioning the device around the clad member to be repaired, using suitable external technological means, tightening the device inducing the compression of the gel type elastomer compound, attaching the device definitively and removing the external positioning means.

### Examples of Composition of the Gel Type Elastomer Compound

A plurality of gel type elastomer compounds were produced with different sequenced copolymers and different hydrocarbon bases and different proportions of copolymers in said hydrocarbon bases.

The gel type elastomer compound was prepared using the following method:

The physical mixture of the sequence copolymer belonging to the Kraton® family and the hydrocarbon base was heated to 140° C. until a homogeneous liquid was obtained according to a temperature rise of 120° C. for an 8-hour period and heated to the final temperature of 140° C. for two hours. This mixture is then deaerated in a 1 bar vacuum, said deaeration being performed over a period of the order of 2 to 3 hours by means of a vacuum pump.

The mould is filled gravitationally, the mould being inclined to prevent any air bubble formation during filling. The mould is heated by a heating belt, making it possible to maintain the mould at the desired temperature during casting. The filled mould is then slowly returned to the horizontal position and allowed to cool to ambient temperature. This method ensures satisfactory filling and prevents the formation of air pockets. The filling time is of the order of 15 to 30 minutes according to the size of the elastomer compound to be produced.

The selected elastomer polymer is a tri-block linear copolymer comprising a styrene type rigid segment, an ethylene/butylene type flexible segment, (S-E/B-S), with a quantity of styrene of 33% by mass, having the brand name Kraton® G-1651 E, marketed by KRATON POLYMERS.

Furthermore, another tri-block linear copolymer known as Kraton® “experimental prototype” was also tested. It consists of Kraton® MD6933 with the same composition as Kraton® G-1651 E, with a larger ethylene butylenes block (EB), i.e. a higher molecular weight, thus enabling improved mechanical and thermal stabilities of the resulting gel.

Kraton® G 1651 E is introduced at a rate of 10% by weight into the final composition.

The selected hydrocarbon base is a gas oil type aliphatic solvent with a flash point of 135° C., sold under the brand name Hydroseal® G3H by TOTAL. Hydroseal® G3H is introduced at a rate of 89% by weight into the final composition.

Known additives, biocidal agents and antioxidant agents, are both added at a rate of 1% by weight into the final composition.

The physical characteristics of the gel type elastomer compound obtained vary as a function of the percentage of tri-block sequences copolymer present in the composition. The physical characteristics, particularly the dropping point, expressed in ° C., and firmness of the gel, expressed in terms of maximum penetration resistance force in Newton, of the gel type elastomer compound, obtained from a composition comprising Kraton® G-1651 E and Hydroseal® G3H, are given in table 1 below:

TABLE 1
Influence of copolymer content in composition
on gel dropping point and firmness.

| % Kraton ® | | |
|---|---|---|
| G-1651 E | | Maximum |
| copolymer by | Dropping | resistance |
| weight in | point | force |
| composition | (° Celsius) | (Newton) |
| 5 | 95 +/− 1 | 7 |
| 8 | 110 +/− 1 | 12 |
| 9 | 114 +/− 1 | 15 |
| 10 | 121 +/− 1 | 17 |

The mechanical and physicochemical characteristics of the gel type elastomer compound produced in this way are closely dependent on the tri-block sequenced copolymer content of the composition, the dropping points also being strongly correlated with the mechanical properties.

The effect of the solvent power of the hydrocarbon bases on the characteristics of the gel type elastomer compound is shown in table 2. The variables are, respectively, the density measured at 15° C., of the gel type elastomer compound produced in this way, according to the composition and dropping point expressed in ° C.

The tri-block sequenced copolymer of the composition is still Kraton® G-1651E, present in the composition at a rate of 8% by weight. The hydrocarbon base used is respectively the Hydroseal® G3H mentioned above, and Hydroseal® G240H, having a flash point of 112° C.

Other hydrocarbon bases were also used, particularly Linpar® which are high-purity n-paraffins marketed by SASOL Italy S.p.A, more specifically Linpar® C10-13 and Linpar® C18-20, Linpar® C10-13 being a light fraction while Linpar® C18-20 is a heavier fraction. Finally, PKWF28/31AF marketed by HALTERMANN was also used.

It should be noted that the dropping points, characteristic of the thermal stability of the gel type elastomer compound, are closely dependent on the solvent power of the hydrocarbon base used in the composition.

Other composition tests were performed with Kraton® FG1901X, rendered polar by grafting maleic anhydride, according to the same quantitative formulations as described above leading to performances resulting from substantially identical mechanical and thermal properties to those obtained with Kraton® G-1651E but an improved adhesion capability on steel, aluminium and other surfaces.

TABLE 2
Influence of type of hydrocarbon base on gel
density at 15° C. and on dropping point in °Celsius

| | | | Gel | Dropping |
|---|---|---|---|---|
| Copolymer | % | | density | point |
| type | copolymer | Base type | @ 15° C. | (°Celsius) |
| Kraton ® G- | 8 | Hydroseal ® | 0.924 | 114 |
| 1651E | | G3H | | |
| | | Hydroseal ® | 0.925 | 110 |
| | | G240H | | |
| | | Linpar ® | 0.759 | 96 |
| | | C10-13 | | |
| | | Linpar ® | 0.873 @ | 146 |
| | | C18-20 | 50° C. | |
| | | PKWF28/31AF | 0.887 | 142 |
| Kraton ® | 8 | Hydroseal ® | — | 146 |
| prototype | | G3H | | |
| MD6933 | | PKWF28/31AF | — | 170 |

The invention has been described on the basis of a rectangular mat shaped by bending around the cladding to be repaired of a line, but the embodiment remains within the scope of the invention if the basic shape consists of a developable surface, such as a prism or cone portion, provided that the casing of such a shape is associated with a gel type elastomer compound, having a malleability enabling the bending and penetration of said elastomer compound partially or completely inside defects, such as cracks 4a, deficiencies 4b, or subsidences 4c.

These developable shapes are advantageously combined with skew portions to partially cover the singular portions, such as spherical plug valves, automatic connectors, or well head members, said skew shapes being obtained by embossing, or by thermoforming in the case of thermoplastics such as polyethylene or polypropylene. The elastomer compound mat is in this case, during the duplicate moulding, confined in a countermould corresponding to said skew surface, so as to create a substantially constant thickness of said mat, optionally with extra thicknesses 16, as described with respect to FIGS. 8a-8b.

1. A device for repairing and fitting heat insulation capabilities of the external cladding of clad members, such as tubular lines, connection members and other clad members, positioned on the seabed, said device consisting of a casing comprising attachment or tightening means, suitable for being mounted on said clad members, wherein the device comprises, inside the casing thereof, a gel type elastomer heat insulation compound, in the form of a solid or perforated lining/mat, rigidly connected to said casing and compressed by tightening on the clad member during the fitting thereof.

2. A device according to claim 1 wherein the gel type elastomer compound comprises at least one elastomeric polymer.

3. A device according to claim 2 wherein the gel type elastomer compound is formed of at least one thermoplastic elastomeric polymer selected from the group consisting of linear, branched, multi-branched and star branching di or tri-block sequenced copolymers.

4. A device according to claim 3 wherein the sequenced copolymer is selected from the group consisting of poly(styrene-ethylene-butylene-styrenes), poly(styrene-ethylene-propylene-styrenes), poly(styrene-ethylene-propylenes), poly(styrene-ethylene-butylenes), poly(styrene-ethylene-ethylene-propylene-styrenes) or combinations thereof.

5. A device according to claim 4 wherein the sequenced copolymer is mixed or combined with a polymer selected from the group consisting of poly(styrene-butadiene-styrenes) (SBS), poly(styrene-butadienes) (SB), poly(styrene-isoprene-styrenes) (SIS), poly(styrene-isoprenes) (SI), poly(styrene-ethylene-propylenes) (SEP), low-viscosity poly(styrene-ethylene-propylene-styrenes) (SEPS), low-viscosity poly(styrene-ethylene-butylene-styrenes) (SEBS), poly(styrene-ethylene-butylenes) (SEB), polybutylenes, poly(ethylene-propylenes) (PE), poly(ethylene-butylenes) (EB), polypropylenes, or polyethylenes.

6. A device according to claim 2 wherein the gel type elastomer compound contains at least one hydrocarbon base.

7. A device according to claim 6 wherein the at least one hydrocarbon base is selected from the group consisting of light hydrocarbons mineral oils resulting from petrochemicals or oil refining vegetable oils, animal oils, polyalphaolefins (PAO), isopolyalphaolefins, polyisobutylenes (PIB) or polybutenes having varied molecular weights, polyalkyleneglycols (PAG), fatty esters, fatty alcohols, and fatty ethers.

8. A device according to claim 6 wherein the at least one hydrocarbon base is selected from the group consisting of paraffinic solvents, paraffinic mineral oils and optionally linear paraffins.

9. A device according to claim 2 wherein the at least one elastomeric polymer of the gel type elastomer compound is present in an amount of 1% to 30% by weight of the final composition.

10. A device according to claim 6 wherein the at least one hydrocarbon base of the gel type elastomer compound is present in an amount of 99% to approximately 58% by weight.

11. A device according to claim 2 wherein the gel type elastomer compound is formed of at least one polysiloxane elastomeric polymer.

12. A device according to claim 2 wherein the gel type elastomer compound is formed of at least one elastomeric polymer selected from the group consisting of polyurethane ether or ester elastomers, polyisoprenes, butadiene styrene copolymers, polybutadienes, nitriles, butyls, polychloroprenes, butadiene acrylonitriles, and natural rubbers.

13. A device according to claim 2 wherein the gel type elastomer compound contains at least one of biocidal agents and antioxidant agents.

14. A device according to claim 13 wherein the additives of the gel type elastomer compound are present in an amount of 0.1% to 6% by weight of the final composition.

15. A device according to claim 2 wherein the gel type elastomer compound is parallelepipedic in shape or takes the shape of a frame optionally enclosed by a base made of the same material as said frame.

16. A device according to claim 2 wherein the gel type elastomer compound is multi-layer.

17. A device according to claim 2 wherein the gel type elastomer compound is rigidly connected to a substrate, forming a multi-layer composite, by means of a welding, adhesive force, or bonding type connection.

18. A device according to claim 17 wherein the substrate consists of a thin metal sheet, cooperating with a grid rigidly connected to said sheet, said grid acting as an anchor for the gel type elastomer compound, during the moulding of said elastomer compound.

19. A device according to claim 17, wherein the multi-layer composite formed of the gel type elastomer compound and the substrate is rigidly connected to the casing by assembling said substrate on said casing.

20. A device according to claim 19 wherein the assembly of said substrate on said casing is performed by means of mechanical attachment or chemical attachment.

21. A device according to claim 20 wherein the attachment means of said substrate on the casing are mechanical fastening.

22. A device according to claim 21 wherein the attachment means engage with the casing so as to compress the elastomer compound against the line of the clad member to be repaired.

23. A device according to claim 22 wherein the substrate is in the form of a semi-rigid or flexible sheet capable of being curved to mould the surface of the line to be repaired by adopting a tubular shape.

24. A device according to claim 23 wherein the casing is made of one part which is rolled around, the edges thereof joining to completely encompass the circumference of the clad member to be repaired.

25. A device according to claim 24 wherein the attachment means are rigidly connected to the casing and comprise two complementary parts mounted on the two opposite edges of the sheet or panel substrate and engage with each other to attach the casing by means of tightening against the clad member to be repaired.

26. A device according to claim 25 wherein the casing consists of two semi-tubular shell type parts each provided with complementary attachment means to those of the other half-shell which engage with each other to attach the two semi-tubular shells to each other so as to create compression of the elastomer compound against the clad member to be repaired.

27. A device according to claim 26 wherein the device is mounted on a clad member to be repaired, and wherein the clad member is an insulating coating.

28. A device according to claim 27 wherein the gel type heat insulation elastomer compound, having the form of a lining is perforated and takes the form of a frame with or without a base.

29. A method for producing a gel type heat insulation elastomer compound, for a device for repairing or fitting heat insulation capabilities of the external cladding of clad members comprising the steps of a) stirring by mixing the elastomeric polymer, the hydrocarbon base and any additives, b) followed by heating to the melting point of the gel type elastomer compound, associated with deaeration, c) followed by hot casting at the same temperature into a mould and d) cooling of said compound, in the mould, followed by e) releasing said compound produced from the mould at ambient temperature.

30. A method for producing a gel type heat insulation elastomer compound, for a device for repairing or fitting heat insulation capabilities of the external cladding of clad members comprising the steps of: (i) producing a pre-gel obtained by introducing a small proportion of a sequenced thermoplastic copolymer in the entire hydrocarbon base, and any additives, said pre-gel being heated to the melting point of the sequenced thermoplastic copolymer, (ii) cooling the pre-gel to ambient temperature, (iii) adding the additional sequenced thermoplastic copolymer in the pre-gel under stirring and deaeration, (iv) filling the mould at a temperature and for a time required to achieve gelling of the elastomer compound, and (v) cooling and cold releasing of elastomer compound from the mould.

31. A method according to claim 30 wherein the quantity of sequenced thermoplastic copolymer in the pre-gel is between 0.5% to 10% by weight with respect to the mixture.

32. A method according to claim 30 wherein the filled mould is heated to a temperature of about 90° C. for a time between 10 and 12 hours.

33. A method for repairing insulation using a device of the type of claim 1 comprising the steps of a) positioning the device around the clad member to be repaired using external positioning means, b) tightening the device inducing the compression of the gel type elastomer compound, c) attaching the device to the clad member and d) removing the external positioning means.

34. (canceled)
